(19) United States
(12) Patent Application Publication
(10) Pub. No.: US 2026/0003105 A1
(43) Pub. Date: Jan. 1, 2026

(54) LENS, OPTICAL COMPONENT, AND METHOD FOR MANUFACTURING OPTICAL COMPONENT

(71) Applicant: SUMITOMO ELECTRIC INDUSTRIES, LTD., Osaka (JP)

(72) Inventors: Yasutaka MIZUNO, Osaka (JP); Manabu SHIOZAKI, Osaka (JP)

(21) Appl. No.: 19/244,329

(22) Filed: Jun. 20, 2025

(30) Foreign Application Priority Data
Jun. 26, 2024 (JP) 2024-102851

(51) Int. Cl. G02B 3/08; G02B 1/00

(52) U.S. Cl. CPC G02B 3/08; G02B 1/002

(57) ABSTRACT

A lens according to one embodiment includes a first surface which is a planar surface perpendicular to a first axis extending along a first direction, and on which light is incident; and a second surface which has a curved shape, and from which the light incident on the first surface is emitted. The second surface includes a plurality of protruding portions formed in a stripe shape extending along a second direction intersecting the first direction.

### CROSS REFERENCE TO RELATED APPLICATIONS

This application claims priority based on Japanese Patent Application No. 2024-102851 filed on Jun. 26, 2024, and the entire contents of the Japanese patent application are incorporated herein by reference.

### TECHNICAL FIELD

The present disclosure relates to a lens, an optical component, and a method for manufacturing an optical component.

### BACKGROUND

Japanese Unexamined Patent Publication No. 2022-530453 describes an optical device including an anti-reflection film. The anti-reflection film reduces the reflectance of the optical device for perpendicularly incident light and obliquely incident light. The anti-reflection film includes a plurality of protruding structures formed on at least one light-transmitting surface included in an optical waveguide. A maximum diameter of each protruding structure and a space formed between two protruding structures adjacent to each other are smaller than the minimum value of any wavelength of visible light. Each protruding structure included in the anti-reflection film has a nanomoth-eye structure that tapers from the bottom portion toward to the upper portion. The plurality of protruding structures are formed by curing using an ultraviolet light irradiation method or a heating method.

Japanese Unexamined Patent Publication No. 2019-113838 describes an anti-reflection film. The anti-reflection film includes a support base material and a moth-eye pattern made of a photoresist material, the dimensions of which increase as the moth-eye pattern approaches the support base material. The cross-sectional shape of the moth-eye pattern is a triangular shape, a trapezoidal shape, or a half-elliptical shape. In the moth-eye pattern, the refractive index is low at the top and high at the bottom. The tapered pattern is formed by a method using a high-absorption resist material and a method using a resist material with low dissolution contrast.

Japanese Unexamined Patent Publication No. 2019-60956 describes a lens which is a glass lens. In the glass lens, a moth-eye structure formed by applying moth-eye processing to an anti-reflection film is formed on a surface of the glass lens facing an object side. The moth-eye structure is composed of an arrangement of a plurality of pillars made of the film material of the anti-reflection film. The plurality of pillars have a substantially conical shape with a rounded apex end, and are arranged across the entire surface of the lens so as to create a form resembling a moth-eye shape as a whole.

Japanese Unexamined Patent Publication No. 2021-136321 describes a light emitting device including a light emitting unit, a drive circuit, a power supply circuit, and a light emitting-side optical system. The light emitting unit is provided inside a laser diode (LD) chip. The LD chip includes a substrate, a multilayer film, a plurality of light emitting elements, a plurality of anode electrodes, and a plurality of cathode electrodes. A plurality of lenses are formed on a back surface of the substrate. The light emitting device includes a moth-eye structure on the surface of each lens. The moth-eye structure includes protruding portions and recessed portions, and the protruding portions and the recessed portions are randomly formed on the surface of the lens. The moth-eye structure is formed by treating the surface of the lens with a mixed liquid containing hydrogen peroxide and ozone.

Japanese Unexamined Patent Publication No. 2019-15826 describes a method for manufacturing an article with a moth-eye pattern. In this manufacturing method, an article including a curved surface in a region to which a moth-eye pattern is to be applied, and an inversion mold on which a moth-eye pattern is formed is prepared. The moth-eye pattern is formed on the article by applying a film-forming material between the article and the moth-eye pattern of the inversion mold, and then pressing the article against the inversion mold.

### SUMMARY

A lens according to the present disclosure includes a first surface which is a planar surface perpendicular to a first axis extending along a first direction, and on which light is incident; and a second surface which has a curved shape, and from which the light incident on the first surface is emitted. The second surface includes a plurality of protruding portions formed in a stripe shape extending along a second direction intersecting the first direction.

### BRIEF DESCRIPTION OF THE DRAWINGS

FIG. 1 is a perspective view showing an optical component according to an embodiment.

FIG. 2 is a perspective view showing a lens according to the embodiment.

FIG. 3 is a view showing protruding portions of the lens according to the embodiment.

FIG. 4 is a view schematically showing the formation of a lens by irradiation with laser light from a 3D printer.

FIG. 5 is a perspective view showing an optical component according to a first modification example.

FIG. 6 is a perspective view showing an optical component according to a second modification example.

FIG. 7 is a perspective view showing an optical component according to a third modification example.

FIG. 8 is a cross-sectional perspective view showing a lens according to a fourth modification example.

FIG. 9 is a graph showing an example of the relationship between the spread angle of light and both the reflectance and the light intensity in each of the case including the protruding portions and the case of not including the protruding portions.

FIG. 10 is a graph showing an example of the relationship between the width and height of the protruding portions and the reflectance of light.

### DETAILED DESCRIPTION

The miniaturization of an optical device such as an optical fiber and a lens attached to an optical device may be required. Attaching a miniaturized lens to an optical device is required. Furthermore, reducing reflection in a miniaturized lens is required.

An object of the present disclosure is to provide a small lens, an optical component and a method for manufacturing an optical component easily attachable to an optical device and capable of reducing the reflectance.

According to the present disclosure, it is possible to provide a small lens easily attachable to an optical device and capable of reducing the reflectance.

First, the contents of an embodiment of the present disclosure will be listed and described. (1) a lens according to one embodiment includes a first surface which is a planar surface perpendicular to a first axis extending along a first direction, and on which light is incident; and a second surface which has a curved shape, and from which the light incident on the first surface is emitted. The second surface includes a plurality of protruding portions formed in a stripe shape extending along a second direction intersecting the first direction.

The lens includes the first surface that is a planar surface perpendicular to the first axis extending along the first direction. Since the first surface can be easily fixed to an optical device by configuring the first surface as a planar surface perpendicular to the first axis, the lens that is miniaturized is easily attachable to the optical device. The plurality of protruding portions are formed in a stripe shape on the second surface having a curved shape, and each of the plurality of protruding portions extends in the second direction intersecting the first direction. The plurality of protruding portions formed in a stripe shape extend in the same direction, and in this specification, this direction is also referred to as a stripe direction. Namely, the second direction is one example of the stripe direction. The reflectance of the light at the second surface can be reduced by forming the plurality of protruding portions in a stripe shape on the second surface, the plurality of protruding portions extending in the second direction intersecting the first direction. Therefore, the reflectance can be reduced.

(2) In (1) above, a cross-sectional shape of the lens perpendicular to the first direction may be a circle, and a diameter of the circle may be 10 μm or more and 100 μm or less. In this case, the lens can be miniaturized. In addition, the lens that is miniaturized is attachable to the optical device, and the optical device to which the lens is attached can be miniaturized.

(3) In (1) or (2) above, the light may be polarized light, and the second direction may coincide with a polarization direction in which an electric field of the light oscillates. When the electric field of the light oscillates in only one direction, the direction is referred to as the polarization direction. In addition, the light in this state is referred to as polarized light. In this manner, the light may be polarized light, and the protruding portions may extend along the polarization direction. For example, the stripe direction may be the same as the polarization direction. In this case, compared to when the second direction is different from the polarization direction of the light, the reflectance of the light at the second surface can be reduced by the plurality of protruding portions formed on the second surface.

(4) In any one of (1) to (3) above, the lens may have an optical axis extending in a direction connecting a center of the first surface and a center of the second surface. The second surface may include a first portion in which, when the light incident on the first surface along the optical axis spreads inside the lens, a spread angle of the light is less than or equal to a Brewster angle and the plurality of protruding portions are formed, and a second portion in which, when the light incident on the first surface along the optical axis spreads inside the lens, the spread angle of the light is larger than the Brewster angle and the plurality of protruding portions are not formed. In a case where the protruding portions are formed in the second portion of the second surface in which, when the light incident on the first surface spreads inside the lens, the spread angle of the light is larger than the Brewster angle, the reflectance of the light may increase in the second portion. Meanwhile, as described above, when the protruding portions are not formed in the second portion, the reflectance of the light in the second portion can be reduced. Therefore, the reflectance of the light can be further reduced.

(5) In any one of (1) to (4) above, a reflectance of the light at the second surface may be 0.1% or less. In this case, the reflectance of the light at the second surface can be further reduced.

(6) An optical component according to the present disclosure is an optical component including the lens described above; and an optical device optically coupled with the lens. The lens is fixed to an end face of the optical device through which light is incident on and emitted from the optical device. For example, when the light is incident on and emitted from an end face of an optical waveguide provided in the optical device, the lens is fixed in alignment with the position of the end face. Since the optical component includes the lens described above, the optical component provides the same effects as those described above.

(7) A method for manufacturing an optical component according to the present disclosure is a method for manufacturing an optical component including the lens described above, and an optical device optically coupled with the lens. The manufacturing method includes a step of forming the lens on an end face of the optical device using a 3D printer that performs irradiation with laser light. The step of forming the lens includes a step of moving the laser light along the second direction. In the step of forming the lens, an uncured material applied to the end face of the optical device is irradiated with the laser light. In the step of forming the lens, the laser light is moved in a direction coinciding with the direction in which the protruding portions extend. In the method for manufacturing an optical component, since the lens described above is formed, the same effects as those of the lens described above are obtained. Furthermore, a small lens can be easily formed on the end face of the optical device by the 3D printer. The laser light moves along the second direction when the lens is formed. Therefore, a small lens having low reflectance can be easily formed on the end face of the optical device.

Specific examples of a lens, an optical component, and a method for manufacturing an optical component according to an embodiment of the present disclosure will be described below with reference to the drawings. The present disclosure is not limited to the following examples, but is intended to include all modifications within the scope of the claims and equivalent thereof. In the description of the drawings, the same or corresponding elements are denoted by the same reference signs, and duplicate descriptions will be omitted as appropriate. The drawings may be depicted in a partially simplified or exaggerated manner for ease of understanding, and dimensional ratios and the like are not limited to those shown in the drawings.

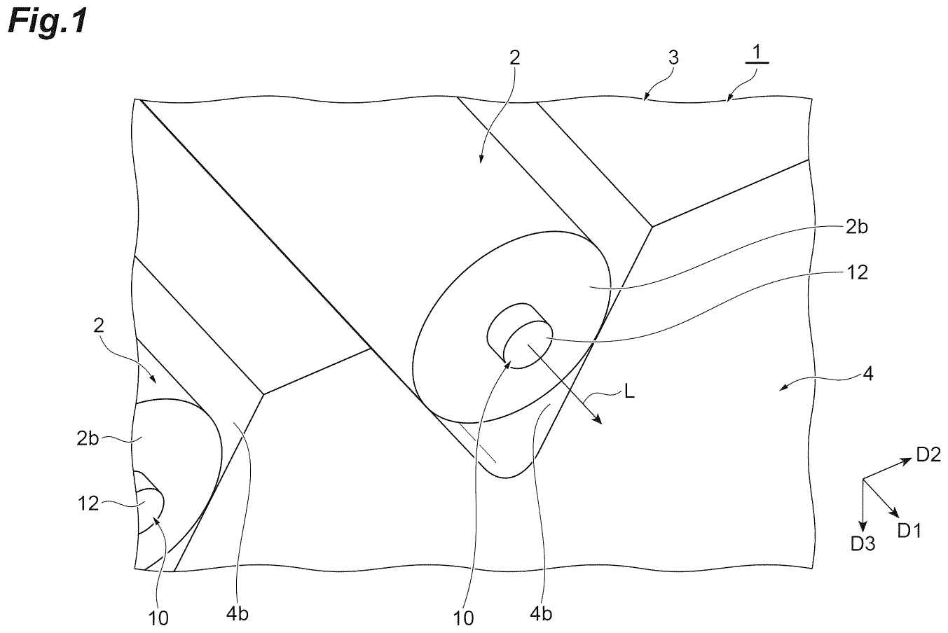

FIG. 1 is a perspective view showing an optical component 1 according to an embodiment. As shown in FIG. 1, the optical component 1 includes a lens 10 on which light is incident, and an optical fiber 2 optically coupled with the lens 10. For example, light emitted from the optical fiber 2 is incident on the lens 10. The optical fiber 2 is one example of an optical device. The optical component 1 includes, for example, an optical fiber array 3. The optical fiber array 3 includes, for example, at least one optical fiber 2 and a V-groove substrate 4 in which at least one V-groove 4b into which the optical fiber 2 is inserted is formed. For example, one optical fiber 2 is fixed in one V-groove 4b. For example, the optical fiber array 3 may further include a pressing substrate (not shown), and the optical fiber 2b may be pressed into the V-groove 4b by the pressing substrate. In the optical component 1, the optical fiber 2 and the V-groove 4b extend along a first direction D1. The optical component 1 includes a plurality of the optical fibers 2, and the V-groove substrate 4 includes a plurality of the V-grooves 4b. The plurality of optical fibers 2 and the plurality of V-grooves 4b are arranged along a second direction D2 intersecting the first direction D1. For example, one of the plurality of optical fibers 2 is fixed in one of the plurality of V-grooves 4b. The pressing substrate may press the plurality of optical fibers 2 into the plurality of V-grooves 4b.

For example, the optical component 1 includes a plurality of the lenses 10, and the plurality of lenses 10 are arranged along the second direction D2. The plurality of lenses 10 may be arranged in an array. For example, the plurality of lenses 10 may be disposed at regular spacing along the second direction D2. The optical fibers 2 extends along the first direction D1, and has an end face 2b at one end portion, to which the lens 10 is fixed, in the first direction D1. The lens 10 is optically coupled with a core of the optical fiber 2. The lens 10 is fixed to, for example, the end face 2b of the optical fiber 2 through which light L is incident on and emitted from the optical fiber 2. For example, the lens 10 is fixed to the end face 2b in alignment with the position of the core of the optical fiber 2.

The end face 2b extends along the second direction D2 and a third direction D3 at the one end portion of the optical fiber 2 in the first direction D1. The end face 2b may have a planar shape extending along the second direction D2 and the third direction D3. The end face 2b has, for example, a circular outer shape. The third direction D3 is a direction intersecting (as one example, orthogonal to) both the first direction D1 and the second direction D2. Hereinafter, the direction in which a bottom portion of the V-groove 4b is located when viewed from the optical fiber 2 placed in the V-groove 4b may be referred to as the bottom, the lower side, or downward, and the direction in which the optical fiber 2 is located when viewed from the bottom portion of the V-groove 4b may be referred to as the top, the upper side, or upward. However, these directions are for convenience of description, and do not limit the disposition position, direction, or the like of an object.

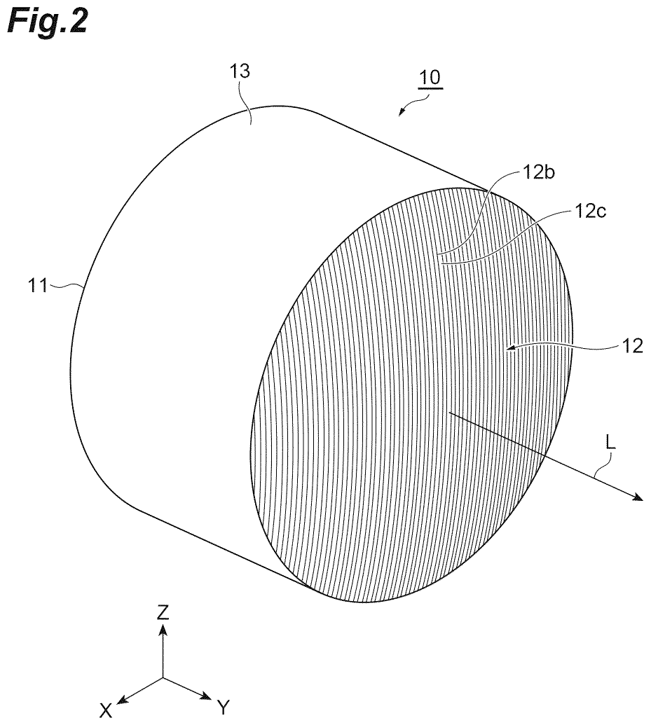

Next, the lens 10 will be described in detail. FIG. 2 is a perspective view showing the lens 10. As shown in FIGS. 1 and 2, the lens 10 emits the light L. A refractive index of the lens 10 is, for example, 1.4 or more and 1.6 or less. For example, the lens 10 is produced by curing a raw material in an uncured state with laser light using a 3D printer. However, the method for producing the lens 10 may be a method other than using a 3D printer, and is not particularly limited. The lens 10 is made of resin. For example, the lens 10 contains an acrylic resin. In addition, the material of the lens 10 may be glass or silicon.

The lens 10 has a first surface 11; a second surface 12 facing opposite to the first surface 11; and a third surface 13 connecting the first 11 and the second surface 12 to each other. The lens 10 has, for example, a columnar shape. As one example, the lens 10 has a circular column shape. The lens 10 is, for example, a small lens that is small enough to be attachable to the end face 2b of the optical fiber 2. When the first surface 11 has a circular shape, a diameter of the first surface 11 is smaller a diameter of the end face 2b. When the lens 10 has a circular column shape, a diameter of the lens 10 is equal to the diameter of the first surface 11 corresponding to the bottom surface of the circular column. For example, the diameter of the lens 10 is 10 μm or more and 100 μm or less. Hereinafter, the direction in which the light L is emitted may be described as a Y direction, the upward direction may be described as a Z direction, and a direction orthogonal to both the Y direction and the Z direction may be described as an X direction. In this case, Y direction in which the light L is emitted is also referred to as an optical axis direction.

The first surface 11 is a surface on which the light L is incident from outside the lens 10. For example, the first surface 11 is an incident surface on which the light L is incident. For example, the light L propagating through the optical fiber 2 is incident on the first surface 11 via the end face 2b. The first surface 11 is a planar surface perpendicular to a first axis extending along the Y direction. Namely, the first surface 11 has a flat shape (flat surface). The Y direction is one example of the first direction D1. The first surface 11 extends, for example, along the Z direction and the X direction. The first surface 11 is a surface that can be fixed to the end face 2b of the optical fiber 2. The first surface 11 has, for example, a circular shape, and has a center O1. The third surface 13 extends from the first surface 11 in the Y direction. The third surface 13 extends, for example, along a circumferential direction that is a direction along a ring centered on the first axis. For example, in the lens 10, the third surface 13 has a circular shape in a cross-section perpendicular to the first direction D1 or in a cross-section parallel to the first surface 11.

The second surface 12 is, for example, an emitting surface from which the light L is emitted. The second surface 12 has a curved shape. The second surface 12 has, for example, an aspherical shape. The second surface 12 has a center O2 when viewed along the Y direction (namely, in a plan view of the second surface 12). For example, the second surface 12 protrudes in the Y direction. In this case, the lens 10 is a concave lens. For example, a distance between the center of the second surface 12 and the first surface 11 is larger than a length of the third surface 13 in the Y direction. For example, the lens 10 may be a condenser lens that focuses the light L when the light L incident on the first surface 11 is emitted from the second surface 12. In addition, the lens 10 is a collimating lens that converts the light L into parallel light when the light L incident on the first surface 11 is emitted from the second surface 12. However, the lens 10 may be a convex lens, and in this case, the second surface 12 is concave in a direction opposite to the Y direction. In this case, the distance between the center of the second surface 12 and the first surface 11 is smaller than the length of the third surface 13 in the Y direction. For example, the lens 10 configured as a convex lens emits the light L as diffused light. The lens 10 has an optical axis extending along a straight line connecting the center O1 of the first surface 11 and the center O2 of the second surface 12. An extending direction of the optical axis is also referred to as an optical axis direction. The first direction D1 may be the same as the optical axis direction. When the light L is incident on the first surface 11 along the optical axis, the light L is emitted from the second surface 12 along the optical axis. In this case, the light L has the same optical axis as the optical axis of the lens 10. For example, when the second surface 12 has a spherical shape, the center O2 may the center of curvature. The second surface 12 includes a plurality of protruding portions 12c, each of which extends in a direction intersecting the first direction D1.

For example, each of the plurality of protruding portions 12c extends along the Z direction in a plan view of the second surface 12. The plurality of protruding portions 12c are arranged along the X direction in a plan view of the second surface 12. A gap 12b is provided between two protruding portions 12c adjacent to each other. Namely, the plurality of protruding portions 12c are spaced apart from each other by a plurality of the gaps 12b. In this manner, the plurality of protruding portions 12c are formed in a stripe shape. The plurality of protruding portions 12c formed in a stripe shape on the second surface 12 of the lens 10 forms, for example, a metamaterial structure that gradually changes the refractive index of light passing through the lens 10 along the Y direction. The plurality of protruding portions 12c forming a metamaterial structure form a reflection reduction structure that reduces the reflection of the light L passing through the lens 10. A reflectance of the lens 10 (second surface 12) is, for example, 0.1% or less.

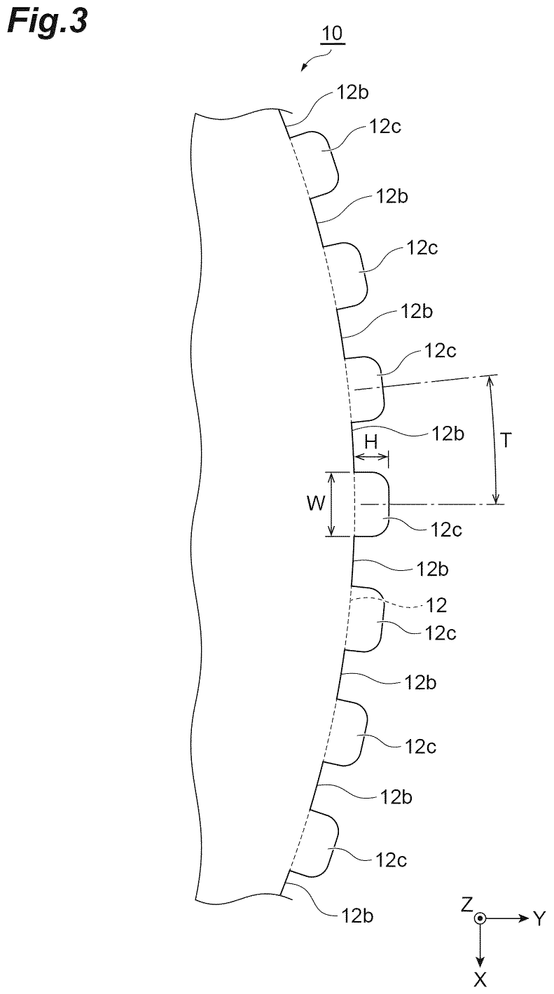

FIG. 3 is an enlarged view of the plurality of protruding portions 12c when viewed along the Z direction. As shown in FIGS. 2 and 3, when viewed along the Z direction, the protruding portion 12c has, for example, a rectangular shape. However, the shape of the protruding portion 12c when viewed along the Z direction may be a rectangular shape with rounded outer corners facing the outside, or may be, for example, a semi-elliptical shape, and is not limited to a shape with angular corners. For example, the second surface 12 is curved to protrude in the Y direction. The second surface 12 has the gap 12b formed between two protruding portions 12c arranged along the surface curved in the X direction. The gap 12b is also referred to as a recessed portion. The plurality of protruding portions 12c are spaced apart from each other by the gaps 12b. The second surface 12 includes the plurality of protruding portions 12c, and the protruding portions 12c and the gaps 12b are alternately arranged in order on the second surface 12 in the X direction. The shape of the bottom portion of the gap 12b when viewed along the Z direction may be rounded, for example, similarly to the shape of the outer corners of the protruding portion 12c when viewed along the Z direction. In this case, for example, the protruding portion 12c on the second surface 12 may have a rounded convex shape, and the gap 12b on the second surface 12 may have a rounded concave shape. On the second surface 12, periodic protrusions and recesses are formed along the X direction by the plurality of protruding portions 12c and the plurality of gaps 12b.

For example, a height H of the protruding portion 12c (a depth of the gap 12b) is 200 nm or more and 500 nm or less. The height H of the protruding portion 12c indicates the length of the protruding portion 12c from the bottom surface of the gap 12b in a direction orthogonal to the bottom surface of the gap 12b. The protruding portion 12c is provided on the second surface 12, and when the outer corners of the protruding portion 12c are rounded, the height H of the protruding portion 12c may be a distance from the second surface 12 to a portion of the protruding portion 12c that protrudes the farthest from the second surface 12 (for example, an apex). A width W of the protruding portion 12c is, for example, 200 nm or more and 600 nm or less. The width W of the protruding portion 12c indicates the length of the protruding portion 12c in a direction parallel to an extending direction of the bottom surface of the gap 12b when viewed along the Z direction. The width W of the protruding portion 12c can be measured as a distance between two gaps 12b that sandwich one protruding portion 12c. For example, when the bottom portion of the gap 12b is rounded, the distance between the gaps 12b may be measured at half the height H of the protruding portion 12c. For example, the plurality of protruding portions 12c are arranged at equal spacing on the second surface 12 along the X direction. In this case, a period T of the plurality of protruding portions 12c is, for example, 400 nm or more and 1000 nm or less. The period T of the plurality of protruding portions 12c indicates a distance from the center of one protruding portion 12c in the direction parallel to the extending direction of the bottom surface of the gap 12b when viewed along the Z direction to the center of the protruding portion 12c, which is adjacent to the one protruding portion 12c, in the direction. The period T is equal to the sum of the width W of the protruding portion 12c and the width of the gap 12b.

Next, an example of the method for manufacturing an optical component according to the present embodiment will be described. Hereinafter, an example of a method for manufacturing the optical component 1 including the lenses 10 and the optical fibers 2 that are optical devices. As one example, the V-groove substrate 4 in which the V-grooves 4b are formed is prepared, and the optical fiber array 3 is produced by placing the optical fibers 2 in the V-grooves 4b. Then, the lens 10 is formed on the end face 2b of each of the optical fibers 2. In the optical fiber array 3, the plurality of optical fibers 2 are placed at regular spacing in the direction in which the plurality of optical fibers 2 are arranged.

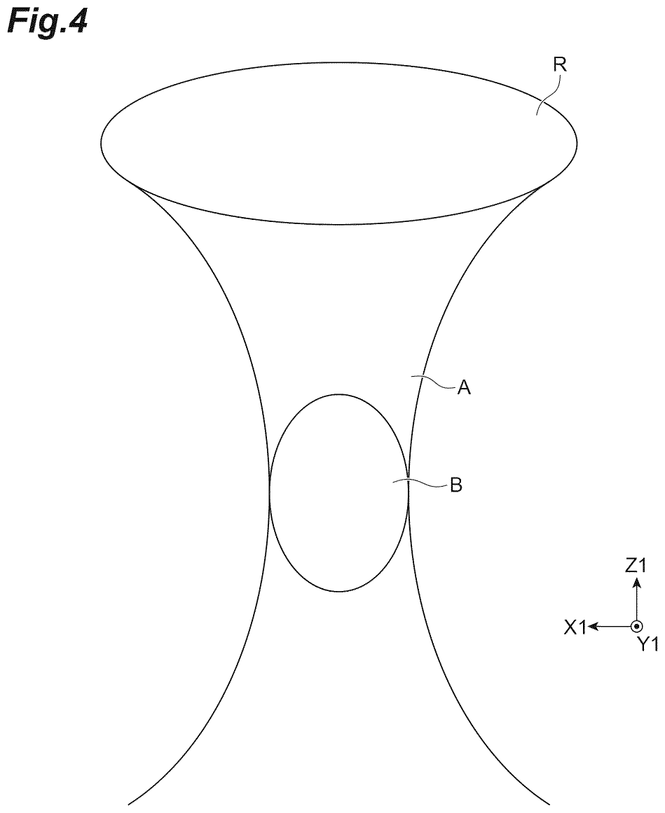

As described above, for example, the lens 10 is formed on the end face 2b by a 3D printer. As schematically shown in FIG. 4, the 3D printer forms the lens 10 on the end face 2b, for example, by moving laser light A using a condenser lens R to continuously form a cured region B of the raw material (for example, resin) of the lens 10 in three dimensions on the end face 2b. The raw material of the lens 10 is applied to the end face 2b in an uncured state. When the uncured raw material is heated and cured by irradiation with the laser light A, the lens 10 is fixed onto the end face 2b by the curing. The cured region B has an elliptical shape having a major axis extending along a Z1 direction. The Z1 direction is the direction in which the laser light A travels, and is the optical axis direction of the condenser lens R. A width of the cured region B (a length of the minor axis) is, for example, 400 nm, and a length of the cured region B (a length of the major axis) is 1200 nm. The cured region B has a minor axis in at least one of an X1 direction and a Y direction intersecting the Z1 direction and intersecting each other.

As described above, the lens 10 is formed on the end face 2b by moving the laser light A using a 3D printer to continuously form the cured region B in three dimensions on the end face 2b (a step of forming a lens using a 3D printer). In forming the lens 10, the protruding portions 12c of the second surface 12 are formed by moving the laser light A for irradiation. At this time, the 3D printer moves the laser light A in a direction coinciding with the direction in which stripes composed of the plurality of protruding portions 12c extend (stripe direction). For example, the 3D printer irradiates the second surface 12 with the laser light A along the Z1 direction. By moving the laser light A in one of the X1 direction and the Y1 direction to continuously form the cured region B in the stripe direction, the width of the protruding portions 12c can be reduced according to the length (width) of the cured region B in a minor axis direction. When the uncured raw material of the lens 10 is cured by irradiation with the laser light A to form the plurality of protruding portions 12c on the second surface 12, the gap 12b is formed by forming another protruding portion 12c adjacent to one protruding portion 12c so as to be spaced apart therefrom. Accordingly, the second surface 12 on which the protruding portions 12c and the gaps 12b are alternately formed in a stripe shape is formed by the 3D printer, and thereafter, the lens 10 is completed, so that a series of the steps in the method for manufacturing the optical component 1 is completed.

Next, effects obtained from the lens 10, the optical component 1, and the method for manufacturing an optical component according to the present embodiment will be described. In the lens 10, the optical component 1, and the method for manufacturing an optical component according to the present embodiment, the lens 10 has the first surface 11 that is a planar surface perpendicular to the first axis extending along the first direction D1. Since the first surface 11 can be easily fixed to the end face 2b of the optical fiber 2 by configuring the first surface 11 as a planar surface perpendicular to the first axis, the lens 10 that is miniaturized is easily attachable to the optical fiber 2. For example, when the end face 2b is a planar surface, the first surface 11 is easily attachable to the end face 2b by configuring the first surface 11 as a planar surface facing the end face 2b. The first axis may be the optical axis of the lens 10. When the end face 2b includes protrusions and recesses, protrusions and recesses may be provided on the first surface 11 in alignment with the protrusions and recesses such that the end face 2b and the first surface 11 come into close contact with each other. The plurality of protruding portions 12c are formed on the second surface 12 having a curved shape, and each of the plurality of protruding portions 12c extends in a stripe shape in a direction intersecting the optical axis. A metamaterial structure is formed by spacing the plurality of protruding portions 12c apart from each other using the gaps 12b, each of the protruding portions 12c extending in the direction intersecting the optical axis, and forming the plurality of protruding portions 12c in a stripe shape on the second surface 12, so that the reflectance of the light L at the second surface 12 can be reduced. Therefore, the reflectance can be reduced.

As described above, the diameter of the lens 10 may be 10 μm or more and 100 μm or less. In this case, the lens 10 can be miniaturized. By setting the diameter of the first surface 11 of the lens 10 to be smaller than the diameter of the end face 2b of the optical fiber 2, the lens 10 is easily attachable to the optical fiber 2. Furthermore, the optical component 1 in which the lens 10 is attached to the optical fiber 2 can be miniaturized. As described above, the reflectance of the light L at the second surface 12 may be 0.1% or less. In this case, the reflectance of the light L at the second surface 12 can be further reduced.

In the method for manufacturing an optical component according to the present embodiment, the lens 10 can be easily formed on the end face 2b of the optical fiber 2 by a 3D printer. When the lens 10 is formed, the laser light A with which resin applied on the second surface 12 is irradiated is moved in the direction coinciding with the direction in which the protruding portions 12c extend in a stripe shape (for example, the Z direction). Therefore, the lens 10 that is small and has low reflectance can be easily formed on the end face 2b of the optical fiber 2 by using the sophisticated 3D printing technique.

Subsequently, lenses, optical components, and methods for manufacturing optical components according to modification examples will be described. A part of the lens, the optical component, and the method for manufacturing an optical component according to each modification example to be described later is the same as the lens 10, the optical component 1, and the method for manufacturing an optical component according to the above-described embodiment. Therefore, in the following description, descriptions that overlap with those of the lens 10, the optical component 1, and the method for manufacturing an optical component described above will be omitted as appropriate.

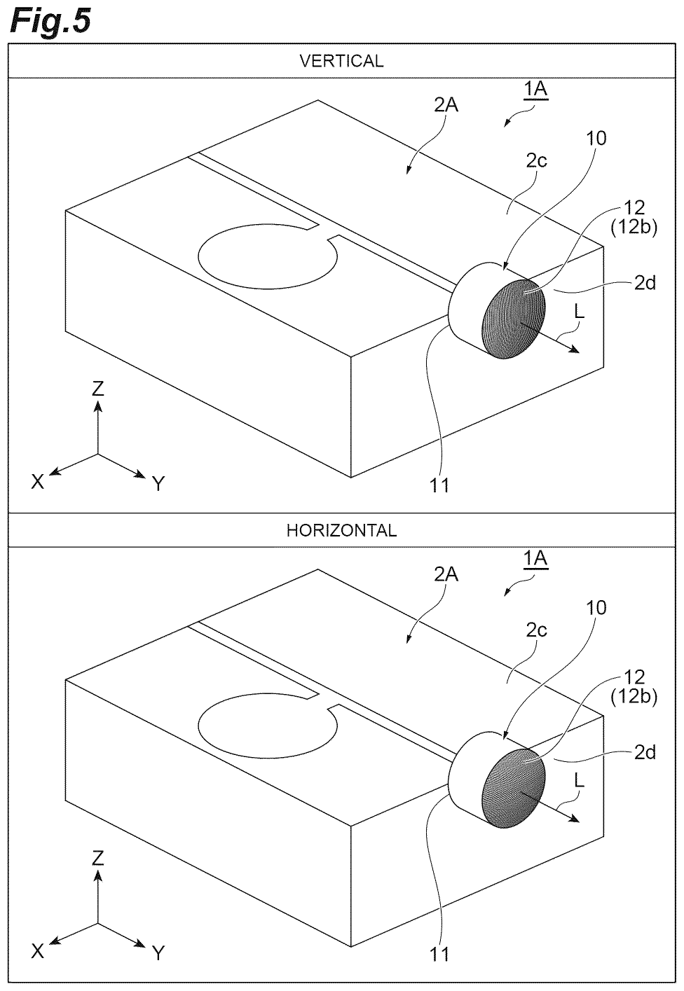

FIG. 5 is a perspective view showing an optical component 1A according to a first modification example. As shown in FIG. 5, the optical component 1A includes the lens 10 and an optical semiconductor device 2A optically coupled with the lens 10. The optical semiconductor device 2A is one example of an optical device. The optical semiconductor device 2A includes, for example, a laser diode (LD). The optical semiconductor device 2A includes at least one of an optical modulator and a semiconductor optical amplifier. The optical semiconductor device 2A includes, for example, a compound semiconductor such as indium phosphide (InP). The optical semiconductor device 2A can emit an optical signal, and has an end face 2d intersecting a substrate surface 2c of the optical semiconductor device 2A. The lens 10 is formed on the end face 2d. For example, the first surface 11 of the lens 10 is in contact with the end face 2d. For example, the light L is polarized light, and the stripes of a plurality of the protruding portions 12c extend along a polarization direction of the light L. The light L is polarized light in which an electric field oscillates in only one direction, and the direction in which the electric field vibrates is referred to as the polarization direction. “Vertical” in FIG. 5 indicates an example in which the polarization direction is the Z direction, and “horizontal” in FIG. 5 indicates an example in which the polarization direction is the X direction. In the case of “vertical” in FIG. 5, the stripe direction of the plurality of protruding portions 12c is along a Z-axis, and in the case of “horizontal” in FIG. 5, the stripe direction of the plurality of protruding portions 12c is along an X-axis.

A method for manufacturing the optical component 1A will be described. When the polarization direction of the light L is the Z direction, the method for manufacturing the optical component 1A is the same as the method for manufacturing the optical component 1 described above. When the polarization direction of the light L is the X direction, the optical semiconductor device 2A is erected such that the substrate surface 2c extends along the X direction and the Z direction (a step of erecting an optical device). In a state where the optical semiconductor device 2A is erected in this manner, the uncured raw material (for example, resin) of the lens 10 is applied to the end face 2d, and a 3D printer irradiates the raw material on the end face 2d with the laser light A (a step of performing irradiation with laser light). At this time, irradiation with the laser light A is performed along the Z direction.

Then, the cured region B is continuously formed in three dimensions from the uncured raw material by irradiating the end face 2d with the laser light A to form the lens 10 on the end face 2d (a step of forming a lens using a 3D printer). At this time, the second surface 12 including the protruding portions 12c parallel to the substrate surface 2c is formed by irradiating the end face 2d with the laser light A. After the plurality of protruding portions 12c having a stripe direction parallel to the substrate surface 2c are formed on the second surface 12, the formation of the lens 10 for the optical semiconductor device 2A is completed. Then, after the optical semiconductor device 2A is tilted such that the substrate surface 2c faces the Z direction in the same manner as before the step of erecting the optical device, a series of the steps in the method for manufacturing the optical component 1A is completed.

As described above, in the optical component 1A, the plurality of protruding portions 12c are formed in a stripe shape on the second surface 12 having a curved shape, and each of the plurality of protruding portions 12c extends in the direction intersecting the first axis. Therefore, in the optical component 1A, similarly to the optical component 1 described above, a metamaterial structure is formed by forming the plurality of protruding portions 12c in a stripe shape on the second surface 12, each of the protruding portions 12c extending in the direction intersecting the first axis, so that the reflectance of the light L at the second surface 12 can be reduced. Furthermore, the light L is polarized light, and the stripes composed of the plurality of the protruding portions 12c extend along the polarization direction. Therefore, the reflectance of the light L at the second surface 12 can be reduced by the plurality of protruding portions 12c formed in a stripe shape on the second surface 12.

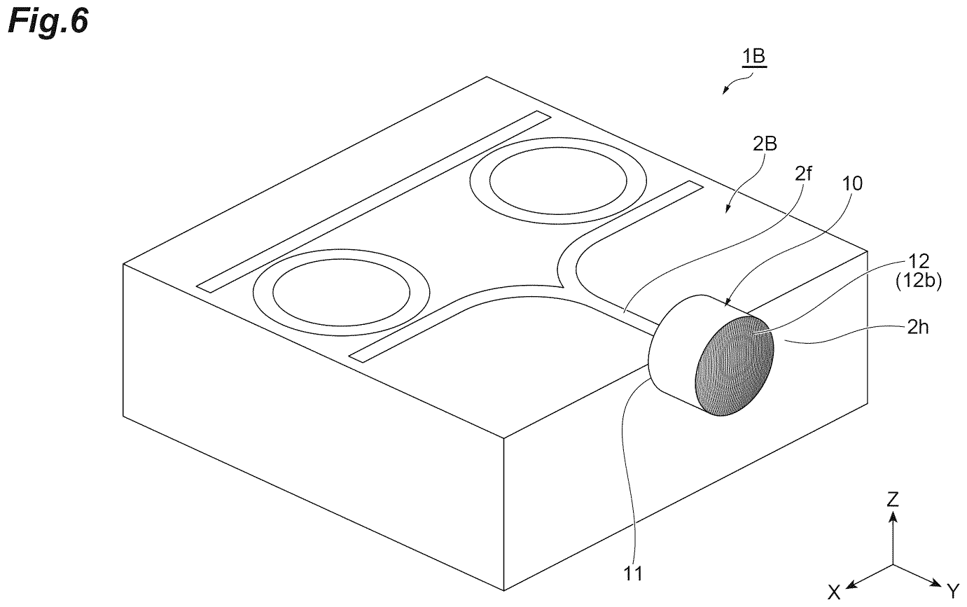

FIG. 6 is a perspective view showing an optical component 1B according to a second modification example. As shown in FIG. 6, the optical component 1B includes the lens 10 and a silicon photonics device 2B optically coupled with the lens 10. The silicon photonics device 2B is one example of an optical device. The silicon photonics device 2B includes an optical waveguide 2f formed on an upper surface extending in both the X direction and the Y direction. The silicon photonics device 2B has an end face 2h which intersects the upper surface, and to which the lens 10 is fixed. The end face 2h extends in both the X direction and the Z direction. The lens 10 fixed to the end face 2h is optically coupled with the optical waveguide 2f. For example, the lens 10 is fixed to the end face 2h such that the position of the optical waveguide 2f on the end face 2h coincides with the center O1 of the first surface 11 of the lens 10. A method for manufacturing the optical component 1B is the same as the method for manufacturing the optical component 1A described above.

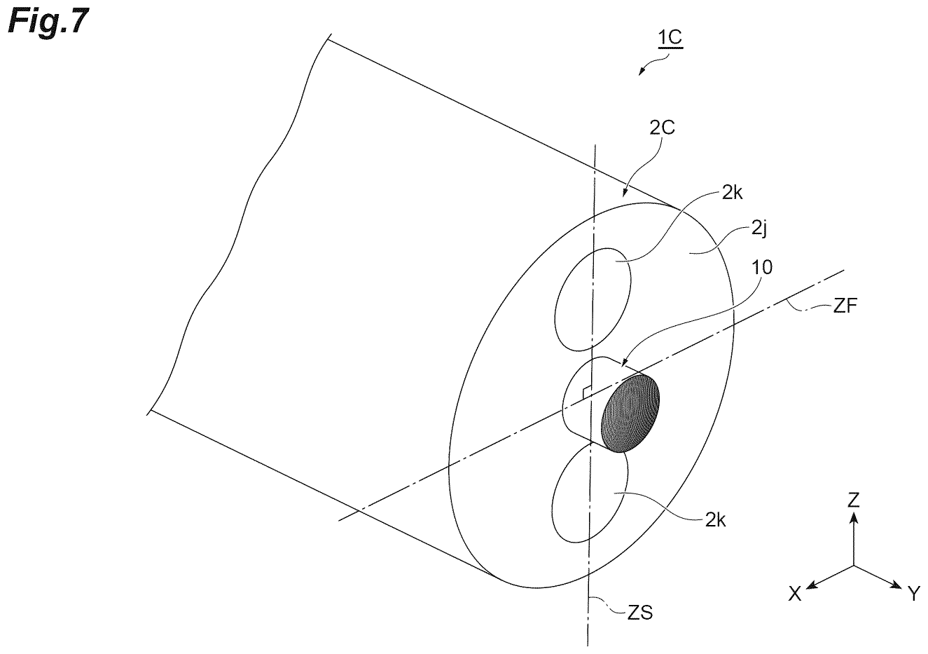

FIG. 7 is a perspective view showing an optical component 1C according to a third modification example. The optical component 1C includes the lens 10 and a polarization-maintaining fiber 2C. The polarization-maintaining fiber 2C is one example of an optical device. The polarization-maintaining fiber 2C includes an end face 2j to which the lens 10 is fixed, and a pair of stress-applying portions 2k exposed at the end face 2j. The end face 2j emits, for example, light, which propagates through the polarization-maintaining fiber 2C, along the Y direction. The shape of the stress-applying portions 2k exposed at the end face 2j is, for example, a circular shape, and is not particularly limited. An axis along a disposition direction of the pair of stress-applying portions 2k is a slow axis ZS, and an axis perpendicular to the slow axis ZS is a fast axis ZF. For example, the slow axis ZS extends along the Z direction, and the fast axis ZF extends along the X direction. The lens 10 fixed to the end face 2j is optically coupled with a core of the polarization-maintaining fiber 2C. For example, the lens 10 is fixed to the end face 2j such that the position of the core on the end face 2j coincides with the center O1 of the first surface 11 of the lens 10. A method for manufacturing the optical component 1C is the same as the method for manufacturing the optical component 1A described above.

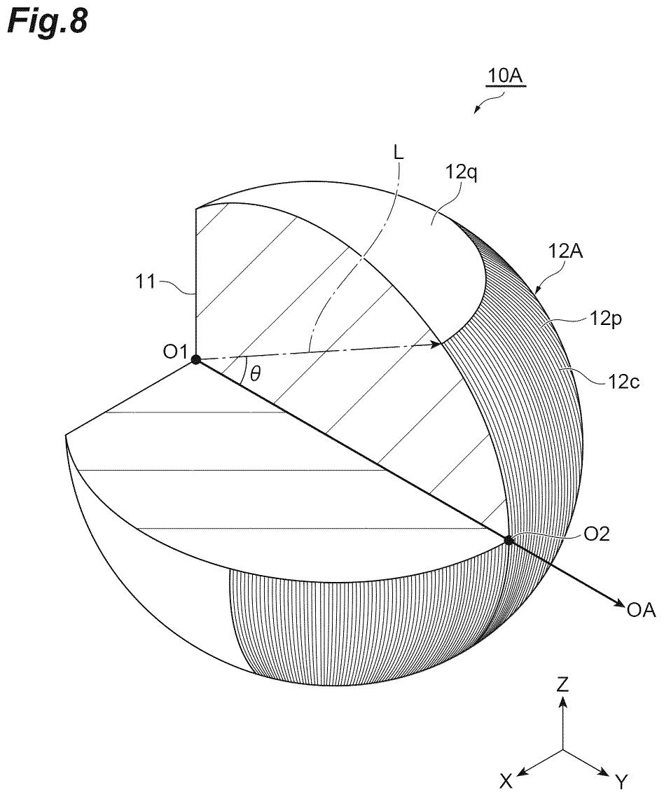

FIG. 8 is a cross-sectional perspective view showing a lens 10A according to a fourth modification example. As shown in FIG. 8, the lens 10A has the first surface 11 and a second surface 12A having a curved shape and extending in a convex shape from the first surface 11 in the Y direction. The lens 10A does not have the third surface 13 of the lens 10 described above. The second surface 12A is formed to be connected to the first surface 11. The surface of the lens 10A is composed of the first surface 11 and the second surface 12A. A curvature of the second surface 12A is larger than a curvature of the second surface 12 of the lens 10. For example, the second surface 12A has an aspherical shape. However, the shape of the second surface 12A is closer to a sphere than the shape of the second surface 12. The second surface 12A may have a spherical shape. The first surface 11 has the center O1. For example, when the first surface 11 has a circular shape, the center O1 becomes the center point of the circle. The second surface 12A has the center O2. For example, in a case where the second surface 12A has a circular shape when viewed along the Y direction, the center O2 becomes the center point of the circle. The lens 10A has a straight line passing through the center O1 and the center O2 as an optical axis OA.

The second surface 12A includes a first portion 12p in which the protruding portions 12c are formed in a stripe shape, and a second portion 12q in which the protruding portions 12c are not formed. The first portion 12p is a region of the second surface 12A in which, when the light L incident on the first surface 11 along the optical axis OA spreads inside the lens 10A, a spread angle θ of the light L is less than or equal to a Brewster angle. The second portion 12q is a region of the second surface 12A in which, when the light L incident on the first surface 11 along the optical axis OA spreads inside the lens 10A, the spread angle θ of the light L is larger than the Brewster angle.

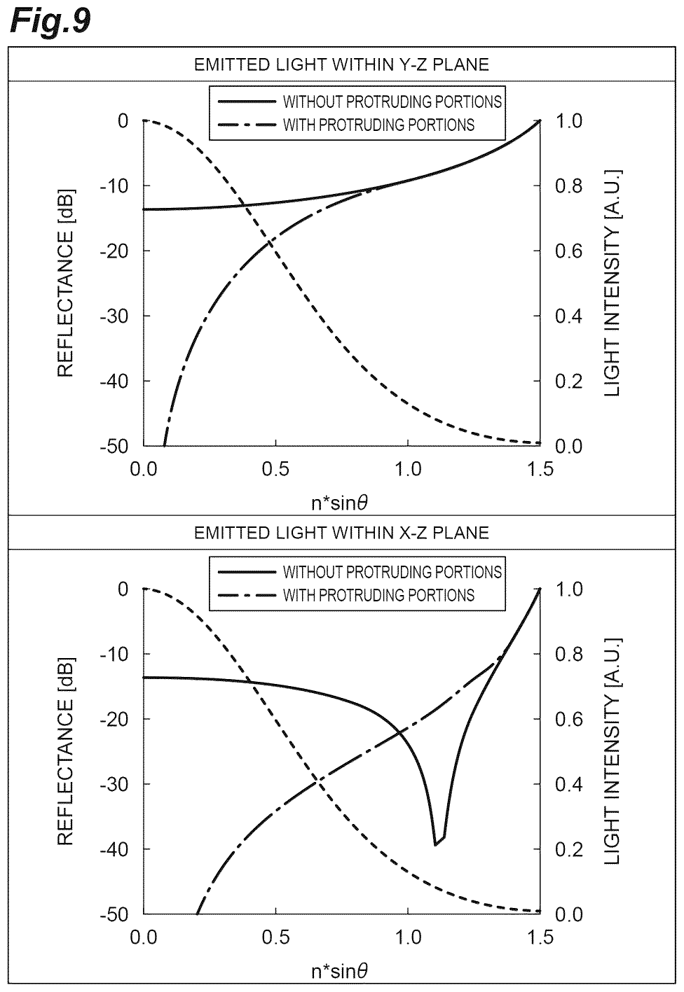

FIG. 9 is a graph showing the relationship between the product of the spread angle θ and a refractive index n (n×sin θ) and the reflectance at the second surface 12A and the relationship between n x sin θ and the light intensity of emitted light from the lens 10A in each of the case of including the protruding portions 12c formed in a stripe shape (with protruding portions) and the case of not including the protruding portions 12c (without protruding portions). The reflectance represents the ratio of the light intensity of light reflected by the second surface 12A to the light intensity of light incident on the first surface 11 inside the lens 10A. In FIG. 9, the value of n is 1.53. As shown in FIGS. 8 and 9, when n×sin θ is 1.0 or less (for example, θ is 40° or less), the reflectance at the second surface 12A can be further reduced in the case of including the protruding portions 12c formed in a stripe shape than in the case of not including the protruding portions 12c.

However, when n×sin θ is larger than 1.0, the reflectance at the second surface 12A can be further reduced in the case of not including the protruding portions 12c than in the case of including the protruding portions 12c formed in a stripe shape. Therefore, in the lens 10A, the reflectance of the light L at the second surface 12A can be further reduced by not forming the protruding portions 12c in the second portion 12q of the second surface 12A in which the spread angle θ is larger than the Brewster angle.

As described above, in the lens 10A, the second surface 12A includes the first portion 12p in which, when the light L incident on the first surface 11 along the optical axis OA spreads inside the lens 10A, the spread angle θ of the light L is less than or equal to the Brewster angle and the protruding portions 12c are formed in a stripe shape, and the second portion 12q in which, when the light L incident on the first surface 11 along the optical axis OA spreads inside the lens 10A, the spread angle θ of the light L is larger than the Brewster angle and the protruding portions 12c are not formed. In a case where the protruding portions 12c are formed in a stripe shape in the second portion 12q of the second surface 12A in which, when the light L incident on the first surface 11 spreads inside the lens 10A, the spread angle θ of the light L is larger than the Brewster angle, the reflectance of the light L may increase in the second portion 12q. On the other hand, as described above, when the protruding portions 12c are not formed in the second portion 12q, the reflectance of the light L in the second portion 12q can be reduced. Therefore, the reflectance of the light L can be further reduced.

Next, an example of a lens according to the present disclosure will be described. The present disclosure is not limited to the following example. In the example, in the lens 10 including the protruding portions 12c shown in FIG. 3, an analysis was performed to verify the width W, the height H, and the period T of the protruding portions 12c. At this time, the distance between two protruding portions 12c adjacent to each other (the width of the gap 12b) is a value obtained by subtracting the width W from the period T. In the example, the reflectance of the second surface 12 when the light L having a peak wavelength 2 of 1550 nm is incident on the first surface 11 of the lens 10 from the core of the optical fiber 2 was analyzed. The refractive index of the core of the optical fiber 2 was set to 1.44, and the refractive index n of the lens 10 was set to 1.53.

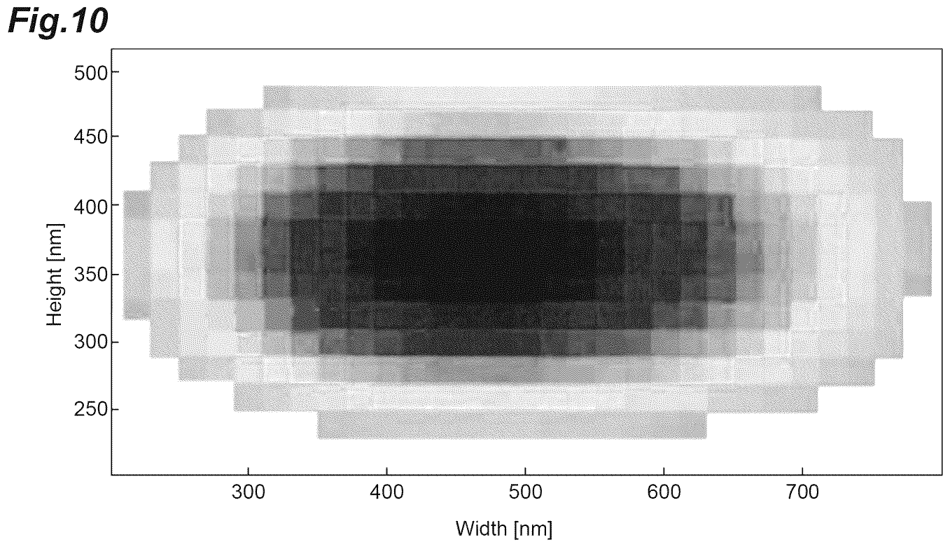

As a result of the analysis, when the period T is A/n or more, for example, when the period T is 1000 nm or more, loss due to diffraction occurred. On the other hand, it has been found that when the period Tis λ/n or less (1000 nm or less), optical loss due to diffraction at the second surface 12 can be reduced. FIG. 10 is a graph showing the reflectance of the second surface 12 according to the width (W) and the height (H) when the period T is 800 nm. In the graph of FIG. 10, the darker the color is, the lower the reflectance is, and the lighter the color is, the higher the reflectance is.

As shown in FIG. 10, when the width W is 300 nm or more and 700 nm or less, and the height H is 250 nm or more and 450 nm or less, the reflectance at the second surface 12 can be further reduced. As one example, when the period T is approximately 800 nm, the width W is approximately 470 nm, and the height H is approximately 360 nm, the reflectance at the second surface 12 can be further reduced. Furthermore, it has been found that, when the height H is λ/6 or more and λ/3 or less, the reflectance at the second surface 12 can be further reduced. Even when the peak wavelength is other than 1550 nm, by appropriately setting the period T of the stripe shape, the width W, and the height H according to the peak wavelength λ of the light transmitting through the lens 10 and the refractive index n of the lens 10, the reflectance at the second surface 12 can be reduced in the same manner as when the peak wavelength λ described above is 1550 nm.

The embodiment, various modification examples, and example of the lens, the optical component, and the method for manufacturing an optical component according to the present disclosure have described above. However, the lens, the optical component, and the method for manufacturing an optical component according to the present disclosure are not limited to the embodiment, the modification examples, and the example described above, and may be further modified within the scope of the concept described in the claims. Namely, the configuration, shape, size, material, number, and disposition mode of each part of the lens and the optical component according to the present disclosure and the contents and order of the steps in the method for manufacturing an optical component can be modified as appropriate within the scope of the concept.

What is claimed is:

1. A lens, comprising:
a first surface which is a planar surface perpendicular to a first axis extending along a first direction, and on which light is incident; and
a second surface which has a curved shape, and from which the light incident on the first surface is emitted,
wherein the second surface includes a plurality of protruding portions formed in a stripe shape extending along a second direction intersecting the first direction.

2. The lens according to claim 1,
wherein a cross-sectional shape of the lens perpendicular to the first direction is a circle, and
a diameter of the circle is 10 μm or more and 100 μm or less.

3. The lens according to claim 1,
wherein the light is polarized light, and
the second direction coincides with a polarization direction in which an electric field of the light oscillates.

4. The lens according to claim 1,
wherein the lens has an optical axis extending in a direction connecting a center of the first surface and a center of the second surface, and
the second surface includes a first portion in which, when the light incident on the first surface along the optical axis spreads inside the lens, a spread angle of the light is less than or equal to a Brewster angle and the plurality of protruding portions are formed, and a second portion in which, when the light incident on the first surface along the optical axis spreads inside the lens, the spread angle of the light is larger than the Brewster angle and the plurality of protruding portions are not formed.

5. The lens according to claim 1,
wherein a reflectance of the light at the second surface is 0.1% or less.

6. An optical component, comprising:
the lens according to claim 1; and
an optical device optically coupled with the lens,
wherein the lens is fixed to an end face of the optical device through which light is incident on and emitted from the optical device.

7. A method for manufacturing an optical component including the
lens according to claim 1, and an optical device optically coupled with the lens, the method comprising:
a step of forming the lens on an end face of the optical device using a 3D printer that performs irradiation with laser light,
wherein the step of forming the lens includes a step of moving the laser light along the second direction.
